(19) United States
(12) Patent Application Publication
(10) Pub. No.: US 2008/0292527 A1
(43) Pub. Date: Nov. 27, 2008

(54) Method for Producing Carbonates

(75) Inventors: Tetsuo Kawano, Kanagawa (JP); Tatsuya Ishizaka, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM CORPORATION, Tokyo (JP)

(21) Appl. No.: 11/792,528

(22) PCT Filed: Dec. 13, 2005
(86) PCT No.: PCT/JP05/23200

§ 371 Date: Jun. 27, 2007

(30) Foreign Application Priority Data
Dec. 15, 2004 (JP) 2004-363483
Dec. 15, 2004 (JP) 2004-363497

(51) Int. Cl. C01B 31/24

(52) U.S. Cl. 423/430; 423/433; 423/419.1

(57) ABSTRACT

The object of the present invention is to provide a method for producing carbonates capable of effectively and easily forming carbonates shaped to have an orientational birefringence and an aspect ratio greater than 1 as well as capable of controlling the particle size. For this end, it is a method of which a metallic ion source containing at least one selected from Sr²⁺ ions, Ca²⁺ ions, Ba²⁺ ions, Zn²⁺ ions, and Pb²⁺ with a carbonate source in a solution to thereby produce carbonates shaped to have an aspect ratio greater than 1, and the method include increasing the number of carbonate particles and increasing the volume of carbonate particles.

### TECHNICAL FIELD

The present invention relates to a method for producing carbonates by which carbonates shaped to have an orientational birefringence and an aspect ratio greater than 1 can be effectively and easily formed, and the particle size thereof can be controlled.

### BACKGROUND ART

Conventionally, carbonates such as calcium carbonates have been widely used in the fields of rubber, plastic, paper and the like. In recent years, carbonates having high-functionality are successively developed and used for various purposes in accordance with the particle shape and the particle diameter.

For crystal forms of carbonates, there are calcite crystal form, aragonite crystal form, vaterite crystal form, and the like. Among them, aragonite crystals of the carbonates have an acicular form and find a fit for many applications in terms of excellence in strength and elastic modulus.

For a method of producing carbonates, there have been typically known a method of which carbonates are produced by reacting a carbonate ion-containing solution with a chloride solution, and a method of which carbonates are produced by reacting a chloride solution with a carbon dioxide gas. In addition, for a method of producing acicular carbonates with aragonite structure, for example, a method of which in the former method stated above, a carbonate ion-containing solution is reacted with a chloride solution under ultrasonic irradiation has been proposed (see Patent Literature 1), and for a method of introducing carbon dioxide in a Ca(OH)₂ water slurry, a method of which acicular aragonite crystals of seed crystals are placed in a Ca(OH)₂ water slurry beforehand, and the seed crystals are made to grow only in a certain direction (see Patent Literature 2).

However, with the method for producing carbonates disclosed in Patent Literature 1, there is a problem that it is impossible to obtain carbonates which are controlled to have a desired particle size, because the length of the obtained carbonates is excessively long, i.e., 30 μm to 60 μm, and the obtained carbonates have a wide particle size distribution. In the carbonate production method described in Patent Literature 2, there is also a problem that it allows only to obtain carbonates having a length of 20 μm to 30 μm.

In recent years, for materials of typical optical components such as glass lenses, and transparent plates, and materials of optical components for opto-electronics, especially for optical components used for laser-related devices such as optical disc devices for recording sounds, images, literal information and the like, there is a strong tendency to use polymeric resins. The reason is that polymeric optical materials (optical materials comprising a polymeric resin) are generally lighter in weight and cheaper compared to other optical materials such as optical glasses, therefore, polymeric optical materials excel in processability and mass productivity. Further, polymeric resins have an advantage that molding techniques such as injection molding and extrusion molding are easily applied.

However, when a conventionally and typically used polymeric optical material is subjected to a molding technique to produce a product, the produced product has a characteristic of exhibiting a birefringence. When polymeric and optical materials having a birefringence are used for optical elements in which high precision is not relatively required, no particular problem arises, however, optical components in which higher precision is required have been requested in recent years. For example, in recordable/erasable magneto-optical discs, the birefringence presents a significant problem. In other words, in these magneto-optical discs, beam deflection techniques are used for reading beam and/or recording beam, and when an optical element such as a disc itself or a lens resides on an optical path, it adversely affects the precision of reading or recording.

Then, aiming to reduce birefringences, a non-birefringent optical plastic material using a polymeric resin and inorganic fine particles which have different birefringent codes each other has been proposed in Patent Literature 3. The non-birefringent optical plastic material can be obtained by a technique called crystal doping method. Specifically, a number of inorganic fine particles are dispersed in a polymeric resin, binding chains of the polymeric resin are orientated generally parallel to the inorganic fine particles by dispersing a number of inorganic fine particles in a polymeric resin and externally affecting a molding force by means of orientation or the like to thereby diminish birefringences caused by the orientation of binding chains of the polymeric resin through the use of birefringences of the inorganic fine particles which have different codes from those of the polymeric resin.

As just described above, to obtain a non-birefringent optical plastic material by the crystal doping method, inorganic fine particles which are usable for the crystal doping method are essential, and for the inorganic fine particles, it is recognized that carbonates shaped to have a microscopic aspect ratio greater than 1, for example, acicular or rod-like carbonates are particularly and suitably usable.

Patent Literature 1 Japanese Patent Application Laid-Open (JP-A) No. 59-203728

Patent Literature 2 U.S. Pat. No. 5,164,172

Patent Literature 3 International Publication No. WO01/25364

### DISCLOSURE OF INVENTION

It is therefore an object of the present invention to provide a method for producing carbonates by which carbonates shaped to have an orientational birefringence and an aspect ratio greater than 1 can be effectively and easily formed, and the particle size thereof can be controlled.

As a result of keen examinations provided by the inventors of the present invention in view of the above noted problems, the following findings were obtained. Namely, the findings are that the particle size of carbonates can be controlled by reacting a metallic ion source containing metallic ions such as Sr²⁺ ions, Ca²⁺ ions with a carbonate source such as ammonium carbonate in a solution, and carbonates shaped to have an aspect ratio greater than 1 can be effectively and easily produced.

The present invention is based on the findings of the inventors, and the means to solve the problems are as follows:

<1> A method for producing carbonates which comprises increasing the number of carbonate particles, and increasing the volume of the carbonate particles, wherein a metallic ion source containing at least one selected from Sr²⁺ ions, Ca²⁺ ions, Ba²⁺ ions, Zn²⁺ ions, and Pb²⁺ ions is reacted with a carbonate source in a solution to thereby produce carbonates shaped to have an aspect ratio greater than 1.

<2> The method for producing carbonates according to the item <1>, wherein the metallic ion source is reacted with the carbonate source by a single-jet method.

<3> The method for producing carbonates according to the item <1>, wherein the metallic ion source is reacted with the carbonate source by a double-jet method.

<4> The method for producing carbonates according to any one of the items <1> to <3>, wherein in the increasing the number of the carbonate particles, the number of moles of the metallic ion source to be reacted is equal to the number of moles of the carbonate source; in the increasing the volume of the carbonate particles, the number of moles of the metallic ion source to be reacted is equal to the number of moles of the carbonate source; and the number of moles of the metallic ion source to be reacted in the increasing the volume of the carbonate particle is greater than the number of moles of the metallic ion source in the increasing the number of the carbonate particles.

<5> The method for producing carbonates according to any one of the items <1> to <3>, wherein in the increasing the number of the carbonate particles, the metallic ion source is reacted with the carbonate source such that the number of moles of the metallic ion source (a) is greater than the number of moles of the carbonate source (b) to produce carbonate particles, and in the increasing the volume of the carbonate particles, the carbonate source is reacted with the metallic ion source such that the number of moles of the carbonate source is greater than the difference between the number of moles of the metallic ion source (a) and the number of moles of the carbonate source (b) to increase the volume of the carbonate particles.

<6> The method for producing carbonates according to any one of the items <1> to <5>, wherein the carbonate source to be reacted in the increasing the number of the carbonate particles and the carbonate source to be reacted in the increasing the volume of the carbonate particles are the same compound.

<7> The method for producing carbonates according to any one of the items <1> to <6>, wherein the increasing the number of the carbonate particles comprises adding at least any one of the metallic ion source and the carbonate source to the solution having a temperature of −10° C. to 40° C. at an adding rate of 0.01 mL/minute to 1,000 mL/minute to be mixed in the solution.

<8> The method for producing carbonates according to any one of the items <1> to <7>, wherein the increasing the volume of the carbonate particles comprises adding at least any one of the metallic ion source and the carbonate source to the solution under a condition of a temperature higher than the reaction temperature in the increasing the number of the carbonate particles and an adding rate of 0.01 mL/minute to 1,000 mL/minute to be mixed.

<9> The method for producing carbonates according to the item <1>, wherein the adding rate and the adding time of the carbonate source are controlled in each of the increasing the number of the carbonate particles and the increasing the volume of the carbonate particles to be reacted with the metallic ion source.

<10> The method for producing carbonates according to the item <9>, wherein in the increasing the number of the carbonate particles, the adding rate of the carbonate source is 300 mL/minute to 2,000 mL/minute and the adding time is 10 seconds to 30 minutes; and in the increasing the volume of the carbonate particles, the adding rate of the carbonate source is less than 300 mL/minute and the adding time is 0.5 hours or more.

<11> The method for producing carbonates according to any one of the items <9> to <10>, wherein the carbonate source is carbon dioxide gas.

<12> The method for producing carbonates according to any one of the items <9> to <11>, wherein the metallic ion source-containing solution is maintained at a temperature of −10° C. to 40° C. in the increasing the number of the carbonate particles.

<13> The method for producing carbonates according to any one of the items <9> to <12>, wherein the reaction temperature in the increasing the volume of the carbonate particles is higher than the reaction temperature in the increasing the volume of the carbonate particles.

<14> The method for producing carbonates according to any one of the items <9> to <13>, wherein the metallic ion source is a metallic hydroxide.

<15> The method for producing carbonates according to any one of the items <1> to <14>, wherein the metallic ion source comprises one or more selected from NO₃⁻, Cl⁻, and OH⁻.

<16> The method for producing carbonates according to any one of the items <1> to <8> and <15>, the carbonate source comprises one or more selected from the group consisting of ammonium carbonates, sodium carbonates, sodium hydrogen carbonates, ureas, and carbon dioxide gases.

<17> The method for producing carbonates according to any one of the items <1> to <2>, <4> to <8>, and <15> to <16>, wherein the increasing the number of the carbonate particles comprises adding a carbonate source-containing aqueous solution to the metallic ion source-containing solution at an adding rate of 0.01 mL/minute to 1,000 mL/minute while maintaining the temperature of the metallic ion source-containing solution at −10° C. to 40° C. to be mixed with the metallic ion source-containing solution, and the increasing the volume of the carbonate particles comprises adding any one of the carbonate source-containing aqueous solution and a gas to the metallic ion-containing solution under a condition of a temperature higher than the reaction temperature in the increasing the number of the carbonate particles and an adding rate of 0.01 mL/minute to 1,000 mL/minute to be mixed.

<18> The method for producing carbonates according to any one of the items <1> to <17>, wherein the solution comprises water.

<19> The method for producing carbonates according to any one of the items <1> to <18>, wherein the solution comprises a solvent.

<20> The method for producing carbonates according to the item <19>, wherein the solvent comprises one or more selected from the group consisting of methanols, ethanols, isopropyl alcohols, and 2-amino ethanols.

### BRIEF DESCRIPTION OF DRAWINGS

FIG. 1 is a conceptual view illustrating the method for producing carbonates of the present invention by means of a double-jet method.

FIG. 2 is a conceptual view illustrating the method for producing carbonates of the present invention by means of a single-jet method.

FIG. 3 is a transmission electron microscope (TEM) photograph of the strontium carbonate crystals produced in Example 1 of the present invention.

FIG. 4 is a transmission electron microscope (TEM) photograph of the strontium carbonate crystals produced in Example 6 of the present invention.

FIG. 5 is a transmission electron microscope (TEM) photograph of the strontium carbonate crystals produced in Example 7 of the present invention.

FIG. 6 is a transmission electron microscope (TEM) photograph of the strontium carbonate crystals produced in Comparative Example 1 of the present invention.

FIG. 7 is a scanning electron microscope (SEM) photograph of the strontium carbonate crystals produced in Comparative Example 2 of the present invention.

### BEST MODE FOR CARRYING OUT THE INVENTION

### (Method for Producing Carbonates)

According to the method for producing carbonates of the present invention, a carbonate source is reacted in a solution of a metallic ion source containing metallic ions to produce carbonates shaped to have an aspect ratio greater than 1.

### —Metallic Ion Source—

The metallic ion source is not particularly limited, provided that the metallic ion source contains metallic ions and may be suitably selected in accordance with the intended use, however, those capable of reacting with the carbonate source and forming carbonates having calcite crystal form, aragonite crystal form, vaterite crystal form or amorphous crystal form are preferably used, and those capable of forming carbonates having aragonite crystal form are particularly preferable.

The aragonite crystal structure is represented by CO₃²⁻ units, and the CO₃²⁻ units are accumulated to form carbonates having any one of an acicular or a rod-like shape. For the reason, when the carbonates are orientated in a given direction by the orientation treatment which will be described hereinafter, the crystals are arrayed in a state where the longitudinal direction of the carbonate particles are arrayed in the orientated direction.

Table 1 shows refraction indexes of minerals in an aragonite crystal form. As shown in Table 1, since carbonates having an aragonite crystal structure have a high birefringent index δ, the carbonates can be suitably used for doping to polymers having an orientational birefringence.

TABLE 1

| | | | | | Specific |
|---|---|---|---|---|---|
| | α | β | γ | δ | Gravity |
| CaCO₃ | 1.530 | 1.681 | 1.685 | 0.155 | 2.94 |
| SrCO₃ | 1.520 | 1.667 | 1.669 | 0.149 | 3.75 |
| BaCO₃ | 1.529 | 1.676 | 1.677 | 0.148 | 4.29 |
| PbCO₃ | 1.804 | 2.076 | 2.078 | 0.274 | 6.55 |

The metallic ion source is not particularly limited, may be suitably selected in accordance with the intended use as long as it contains at least one selected from the group consisting of Sr²⁺ ions, Ca²⁺ ions, Ba²⁺ ions, Zn²⁺ ions, and Pb²⁺ ions, and examples thereof include nitrates, chlorides, and hydroxides of at least one metal selected from Sr, Ca, Ba, Zn, and Pb. Among them, metallic hydroxides are most preferable from the perspective of reactivity.

The metallic ion source preferably comprises one or more selected from NO₃⁻, Cl⁻, and OH⁻. Thus, specific and preferred examples of the metallic ion source include Sr(NO₃)₂, Ca(NO₃)₂, Ba(NO₃)₂, Zn(NO₃)₂, Pb(NO₃)₂, SrCl₂, CaCl₂, BaCl₂, ZnCl₂, PbCl₂, Sr(OH)₂, Ca(OH)₂, Ba(OH)₂, Zn(OH)₂, Pb(OH)₂, and hydrates thereof.

### —Carbonate Source—

The carbonate source is not particularly limited and may be suitably selected in accordance with the intended use as long as it produces CO₃²⁻ ions. Preferred examples of the carbonate source include ammonium carbonates [(NH₄)₂CO₃], sodium carbonates [Na₂CO₃], sodium acid carbonates [NaHCO₃], carbon dioxide gases, ureas [(NH₂)₂CO]. Among them, carbon dioxide gas is especially easy to handle and when an ammonium carbonate, a sodium carbonate and the like are added along with a carbon dioxide gas, it is possible to react the carbonate source with metallic ions without substantially changing the ion concentration and the ionic strength. Thus, the use of carbon dioxide gas hardly causes adverse effects that the obtained carbonate crystals are polydispersed, aggregated each other, and formed in a spherical shape, and the like.

—Method for Reacting a Metallic Ion Source with a Carbonate Source in a Solution—

In the method for reacting the metallic ion source with the carbonate source in a solution, a metallic ion source is reacted with a carbonate source in a solution to produce carbonates shaped to have an aspect ratio greater than 1, and the method comprises increasing the number of carbonate particles (hereinafter referred to as increasing the number of carbonate particles, simply), and increasing only the volume of carbonate particles (hereinafter referred to as increasing the volume of carbonate particles, simply). For example, a first aspect and a second aspect of the method for reacting the metallic ion source with the carbonate source in the solution described below are preferably used from the perspective of reactivity.

According to the first aspect of the method, a metallic ion source is reacted with a carbonate source in a water-based solution by a double-jet method or a single-jet method.

According to the second aspect of the method, in each of the increasing the number of carbonate particles, and the increasing the volume of carbonate particles, the adding rate and the adding time of the carbonate source are controlled to be reacted with metallic ions.

(1) First Aspect of the Method for Reacting a Metallic Ion Source with a Carbonate Source in a Solution.

### <<Double-Jet Method >>

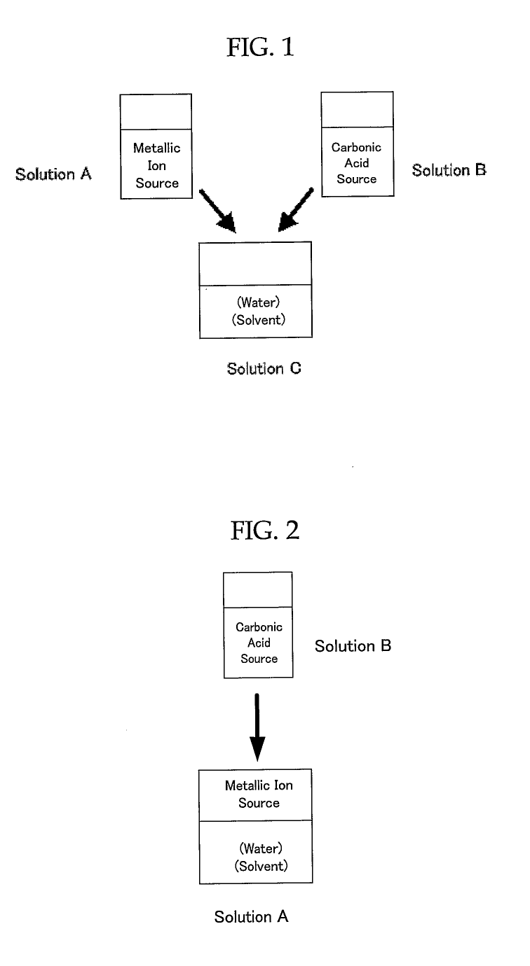

The double-jet method is a method of which the metallic ion source and the carbonate source are respectively added on the surface of a solution or in the solution by injection to be reacted in the solution. For example, as shown in FIG. 1, it is a method of which a metallic ion source-containing solution (A) and a carbonate source-containing solution (B) are injected in a solution (C) at the same time to react them in the (C) solution.

The adding rate of the metallic ion source and the carbonate source based on the double-jet method is not particularly limited, may be suitably selected in accordance with the intended use, however, it is preferred to determine the adding rate such that they are mixed in a stoichiometric mixture ratio of the final product.

The adding rate is not particularly limited, may be suitably selected in accordance with the intended use, however, it is preferably 0.001 mole/minute to 1 mole/minute. It should be noted that the metallic ion source-containing solution (A) may be a suspension containing a metallic ion source.

The double-jet method can be carried out by using, for example, a double-jet reaction crystallizer. The crystallizer has a stirring blade in a reaction vessel, and is equipped with nozzles supplying an initial material solution near the stirring blade, and equipped with two or more nozzles. The metallic ion source-containing solution (A) supplied from a nozzle and the carbonate source-containing solution (B) supplied from another nozzle are mixed to be in a homogenous condition at a fast pace by mixing action of the stirring blade, and it is possible to uniformly react the solution (A) with the solution (B) in the solution (C) instantaneously.

The stirring rate of a reaction crystallizer based on the double-jet method is preferably 500 rpm to 1,500 rpm.

### <<Single-Jet Method >>

The single-jet method is a method of which any one of the metallic ion source and the carbonate source is added to the surface of the other source solution or in the other source solution by injection to be reacted each other.

The single-jet method can also be carried out by using, for example, the above-noted double-jet reaction crystallizer. However, in the single-jet method, just one nozzle is enough to serve, for example, as shown in FIG. 2, it is possible to react a metallic ion source-containing solution (A) with a carbonate source-containing solution (B) in the same manner as in double-jet method by adding the solution (B) injected from a nozzle to the solution (A).

The adding rate of the metallic ion source and the carbonate source and the stirring rate in the single-jet method are not particularly limited, may be suitably selected in accordance with the intended use, however, the adding rate and the stirring rate within the same range of those in the double-jet method are preferable.

### —Increasing the Number of Carbonate Particles—

The increasing the number of carbonate particles is nor particularly limited, may be suitably selected in accordance with the intended use as long as the number of carbonate particles can be increased after forming carbonates, and examples thereof include a step in which at least one of the metallic ion source and the carbonate source is added in a solution with a given reaction temperature to be mixed with the solution.

When reacting these solutions based on a single-jet method, specific and preferred examples thereof include a step in which while maintaining the reaction temperature of any one of a metallic ion source-containing solution or a metallic ion source-containing solution at a given reaction temperature, a carbonate source-containing solution is added to the metallic ion source-containing solution or the suspension at a given adding rate to be mixed each other.

The reaction temperature is preferably −10° C. to 40° C., and more preferably 1° C. to 40° C. When the reaction temperature in the increasing the number of the carbonate particles is lower than −10° C., there may be cases where acicular or rod-like carbonates cannot be obtained, and spherically shaped or elliptical carbonates are formed. When the reaction temperature is more than 40° C., there may be cases where the size of the primary particles of the carbonate particles is increased, and carbonates shaped to have an aspect ratio greater than 1 in a nanometric region.

The adding rate of the carbonate source-containing aqueous solution is not particularly limited, may be suitably selected in accordance with the intended use, however, faster adding is preferable. Specifically, the adding rate is preferably 0.01 mL/minute to 1,000 mL/minute, and more preferably 250 mL/minute to 350 mL/minute.

Each of the number of moles of the metallic ion source and the carbonate source to be reacted in the increasing the number of the carbonate particles is not particularly limited as long as it is within the range where the number of particles can be increased, and the number of moles may be suitably selected in accordance with the intended use. For example, the number of moles of the metallic ion source may be equal to the number of moles of the carbonate source, or a metallic ion source having a number of moles greater than that of a carbonate source may be reacted with the carbonate source to form carbonate particles.

For example, when reacting the metallic ion source and the carbonate source by means of the double-jet method, the metallic ion source and the carbonate source may be respectively added in a reaction liquid to be mixed in the reaction liquid. When reacting them based on the single-jet method, any of the metallic ion source and the carbonate source may be added to the other source to be mixed each other.

For a method for verifying the increased number of the carbonate particles, for example, there is a method of which carbonate particles are observed by using a transmission electron microscope (TEM) or a scanning electron microscope (SEM) to verify that no impurity is mixed therein and then measure the number of the carbonate particles.

### —Increasing the Volume of Carbonate Particles—

The increasing the volume of the carbonate particles is not particularly limited, may be suitably selected in accordance with the intended use, may be suitably selected in accordance with the intended use as long as only the volume of carbonate particles can be increased without increasing the number of the carbonate particles, for example, there is a method of which at least one of the metallic ion source and the carbonate source is added to the other source under a condition of a temperature higher than the reaction temperature of the increasing the number of carbonate particles and of the adding rate slower than that of the increasing the number of carbonate particles to be mixed each other. It should be noted that not to increase the number of carbonate particles in the increasing the volume of carbonate particles mean that the number of carbonate particles after the increasing the volume of carbonate particles does not increase at a percentage more than 40% in proportion to the number of carbonate particles upon completion of the increasing the number of carbonate particles. The number of carbonate particles after the increasing the volume of carbonate particles preferably does not increase at a percentage more than 30% in proportion to the number of carbonate particles upon completion of the increasing the number of carbonate particles, and more preferably does not increase at a percentage more than 20%.

For more specific and preferred steps, for example, there is a step in which any one of the carbonate source-containing aqueous solution and the gas is added under a condition of a temperature higher than the reaction temperature of the increasing the number of the carbonate particles to be mixed each other.

The reaction temperature is preferably −10° C. or more, and more preferably 1° C. to 40° C. When the reaction temperature is lower than −10° C., there is a limitation on the solvent to be used, and therefore, it may be hard to handle the carbonate after forming particles thereof.

The adding rate is not particularly limited and may be suitably selected in accordance with the intended use, for example, the adding rate is preferably 0.01 mL/minute to 1,000 mL/minute, and more preferably 0.1 mL/minute to 50 mL/minute.

The respective numbers of moles of the metallic ion source and the carbonate source to be reacted in the increasing the volume of carbonate particles are not particularly limited and may be suitably selected in accordance with the intended use as long as they are in a range where only the volume of carbonate particles can be increased without increasing the number of carbonate particles. For example, when the number of moles of the metallic ion source to be reacted in the increasing the number of carbonate particles is equal to the number of moles of the carbonate source, it is preferred that the number of moles of the metallic ion source to be reacted be equal to the number of moles in the increasing the volume of carbonate particles, and the number of moles of the metallic ion source to be reacted in the increasing the volume of carbonate particles be more than the number of moles of the metallic ion source in the increasing the number of carbonate particles.

When carbonate particles are formed by reacting the metallic ion source (a) with the carbonate source (b) such that the number of moles of the metallic ion source (a) is greater than the number of moles of the carbonate source (b), it is preferred to react the carbonate source in a number of moles greater than the difference between the number of moles of the metallic ion source (a) and the number of moles of the carbonate source (b) to thereby increase the volume of the carbonate particles, from the perspective of obtaining carbonated with a high aspect ratio.

The carbonate source to be reacted in the increasing the volume of carbonate particles is not particularly limited and may be suitably selected in accordance with the intended use as long as it is any one of the above-mentioned carbonate sources, however, the carbonate source to be reacted in the increasing the number of carbonate particles may be a same compound as that of the carbonate source to be reacted in the increasing the volume of carbonate particles.

For the method for verifying the increased volume of the carbonate particles, for example, there is a method of which carbonate particles are observed by using a transmission electron microscope (TEM) or a scanning electron microscope (SEM) to verify that no impurity is mixed therein and then measure the size of the carbonate particles.

(2) Second Aspect of the Method for Reacting a Metallic Ion Source with a Carbonate Source in a Solution.

### —Increasing the Number of Carbonate Particles—

The increasing the number of carbonate particles is not particularly limited, may be suitably selected in accordance with the intended use as long as the number of carbonate particles can be increased after forming the carbonate, and the adding rate and adding time of the carbonate source of the carbonate source can be controlled to be reacted with the metallic ion source. For example, there is a step in which the carbonate source is added in the metallic ion source-containing solution at a given reaction temperature and a given adding rate for a given time (hereinafter, it may be referred to as adding time) while stirring the metallic ion source.

The reaction temperature is preferably in the same range as mentioned in the first aspect.

The adding rate is preferably 300 mL/minute to 2,000 mL/minute, and more preferably 300 mL/minute to 1,000 mL/minute. When the adding rate is slower than 300 mL/minute, the carbonate particles may be polydispersed. When the adding rate is faster than 2,000 mL/minute, it is hard to control the reaction time, and the aggregation of carbonate particles may get intensified, although so much primary particles can be obtained.

The adding time is preferably 10 seconds to 30 minutes, and more preferably 10 seconds to 10 minutes. When the adding time is shorter than 10 seconds, the reproductivity of carbonate particles may degrade, and when the adding time is longer than 30 minutes, carbonate particles may be polydispersed.

The stirring rate of the metallic ion source-containing solution is not particularly limited, may be suitably controlled, however, it is preferably 500 rpm to 1,500 rpm from the perspective of missing it uniformly.

### —Increasing the Volume of Carbonate Particles—

The increasing the volume of carbonate particles is not particularly limited and may be suitably selected in accordance with the intended use as long as only the volume of the carbonate particles can be increased without increasing the number of the carbonate particles, and the adding rate and the adding time of the carbonate source can be controlled to be reacted, for example, there is a step in which the carbonate source is added in the metallic ion source-containing solution for a given time while stirring the metallic ion source-containing solution under a condition of a temperature higher than the reaction temperature of the increasing the number of the carbonate particles and an adding rate slower than that of the increasing the number of the carbonate particles.

The reaction temperature is preferably in the same range as mentioned in the first aspect.

The adding rate is preferably 300 mL/minute or less, and more preferably 10 mL/minute to 290 mL/minute. When the adding rate is 300 mL/minute or more, the shape based on the aspect ratio of carbonates to be obtained may not be controlled.

The adding time is preferably 0.5 hours or more, and more preferably 1 hour to 48 hours. When the adding time is shorter than 0.5 hours, the shape based on the aspect ratio of carbonates to be obtained may not be controlled.

The stirring rate of the metallic ion source-containing solution is not particularly limited, maybe suitably controlled, however, it is preferably 500 rpm to 1,000 rpm from the perspective of mixing it uniformly.

It is also possible to apply the single-jet method to the second aspect of the method for reacting a metallic ion source with a carbonate source in a solution. The details of the single-jet method are as mentioned in the first aspect of the present invention.

—Solution in which the Metallic Ion Source is Reacted with the Carbonate Source—

The solution in which the metallic ion source is reacted with the carbonate source preferably contains water. Thus, the solution in which the metallic ion source is reacted with the carbonate source is preferably an aqueous solution or a suspension.

Further, with a view to decrease the solubility of crystals of carbonates to be synthesized, the aqueous solution or the suspension preferably comprises a solvent.

The solvent is not particularly limited, may be suitable selected in accordance with the intended use as long as it is a water-miscible solvent, and preferred examples thereof include methanols, ethanols, 1-propanols, isopropyl alcohols, 2-aminoethanols, 2-methoxyethanols, acetones, tetrahydrofurans, 1,4-dioxanes, N,N-dimethylformamides, N,N-dimethylacetamides, N-methylpyrolidones, 1,3-dimethyl-2-imidazolidones, and dimethylsulfoxides. Each of these water-miscible solvents may be used alone or in combination with two or more. Among them, ethanols, isopropyl alcohols, and 2-aminoethanols are particularly preferable from the perspective of reactivity and ease of availability of the material.

The added amount of the solvent is preferably 1% by volume to 50% by volume of the amount of the solvent after producing carbonates, and more preferably 5% by volume to 40% by volume thereof.

### —Physical Properties of Carbonate—

Carbonates to be produced by the method for producing carbonates of the present invention preferably have an aspect ratio greater than 1 and are formed in an acicular or a rod-like shape. It should be noted that the aspect ratio represents a ratio between the length and the diameter of the carbonates, and the greater the value of the aspect ratio is, the more preferable it is.

The average particle length of the carbonates is preferably 0.05 μm to 30 μm, and more preferably 0.05 μm to 5 μm. When the average particle length is more than 30 μm, the carbonate particles may be significantly affected by light scattering, and adaptabilities of the carbonates to optical applications may be reduced.

The percentage of the carbonates having a length of the average particle length ±α in the entire carbonate is preferably 60% or more, more preferably 70% or more, still more preferably 75% or more, and particularly preferably 80% or more. When the percentage is 60% or more, it is recognized that the control of the size of the carbonate particles is highly precise.

The value of α is preferably 0.05 μm to 1.0 μm, more preferably 0.05 μm to 0.8 μm, and particularly preferably 0.05 μm to 0.1 μm.

### —Applications—

Carbonates produced by the method for producing carbonates of the present invention have an aspect ratio greater than 1, thus, the carbonates are formed in an acicular or a rod-like shape, and therefore, the carbonates are useful for plastic reinforcing materials, friction materials, heat insulating materials, filters, and the like. Particularly, a composite material that has been subjected to a deformation such as orientated materials allows improving the intensity and the optical properties by the orientated particles.

When carbonates (crystals) produced by the method for producing carbonates of the present invention are dispersed in an optical polymer having a birefringence, and the dispersion is subjected to an orientation treatment to thereby orientate the binding chains of the optical polymer generally parallel to the carbonate particles, the birefringence brought by the orientation of the binding chains of the optical polymer can be counteracted with the birefringence of the carbonates.

The orientation treatment is not particularly limited, may be suitably selected in accordance with the intended use, and examples thereof include uniaxial orientation. Examples of the method of the uniaxial orientation include orientating a dispersion in which carbonates are dispersed in an optical polymer to a desired orientation ratio using an orientation device while heating the dispersion in accordance with the necessity.

Birefringent indexes specific to optical polymers each having a birefringence are as described on page 29 in Evolving Transparent Resins—World of Sophisticated Optical Materials Challenging IT—First Edition, described by Fumio Ide, published by Kogyo Chosakai Publishing Inc. Table 2 shows specific examples of the birefringent indexes of the optical polymers having a birefringence. Table 2 shows that many of the optical polymers have a positive birefringence. For example, when a strontium carbonate is used as the carbonate and added to a polycarbonate as the optical polymer, it is possible to counteract the positive birefringence of the mixture to make it have zero birefringence as well as to make it have a negative birefringence. For the reason, the carbonates produced according to the present invention can be suitably used for optical elements especially for optical elements of which the deflection property is important and high-precision is required.

TABLE 2

| | Birefringent |
|---|---|
| Polymer | Index |
| Polystyrene | −0.10 |
| Polyphenylene ether | 0.21 |
| Polycarbonate | 0.106 |
| Polyvinylchloride | 0.027 |
| Polymethyl methacrylate | −0.0043 |
| Polyethylene terephthalate | 0.105 |
| Polyethylene | 0.044 |

According to the method for producing carbonates of the present invention, it is possible to easily and effectively form carbonates to have an orientational birefringence and an aspect ratio greater than 1. Further, it is possible to control the size of the carbonate particles as well as to obtain carbonates having a certain particle size at high rates.

### EXAMPLE

Hereafter, the present invention will be described in detail referring to specific examples, however, the present invention is not limited to the disclosed examples.

### Example 1

### Production of Carbonates

As shown in FIG. 2, based on the single-jet method, 375 mL of a 0.08 M strontium hydroxide [Sr (OH)₂] suspension which had been prepared from strontium hydroxide octahydrate as the metallic ion source in a stainless-steel pot was taken as solution A, and the temperature of the solution A was maintained at 10° C. On the other hand, 500 mL of a 0.2 M sodium carbonate [Na₂CO₃] aqueous solution as the carbonate source was taken as solution B, the solution B was then poured into two feed tanks in an amount of 62.5 mL separately, and the temperature of the solution B was maintained at 10° C. While stirring the solution A at 1,000 rpm with the temperature maintained at 10° C., 62.5 mL of the solution B in each of the two feed tanks was respectively added to the solution A in the stainless-steel pot at an adding rate of 300 mL/minute and then mixed (Increasing the number of carbonate particles).

With respect to the obtained carbonates, the particles were observed using a transmission electron microscope (TEM) to verify that no impurity was mixed therein, and then the number of the carbonate particles was measured. It was proved that the number of carbonate particles was increased.

Next, into a vessel, 250 mL of a 0.1 M strontium hydroxide [Sr (OH)₂] suspension (solution A) was poured while stirring the solution A at 1,000 rpm with the temperature maintained at 10° C., and then 250 mL of a 0.1 M sodium carbonate [Na₂CO₃] aqueous solution (solution B) was slowly added to the solution A at an adding rate of 5 mL/minute (Increasing the volume of carbonate particles).

With respect to the obtained carbonate, the particles were observed using a transmission electron microscope (TEM) to verify that no impurity was mixed therein, and then the size of the carbonate particles was measured. It was proved that the volume of carbonate particles was increased.

### —Verification of Carbonate Properties—

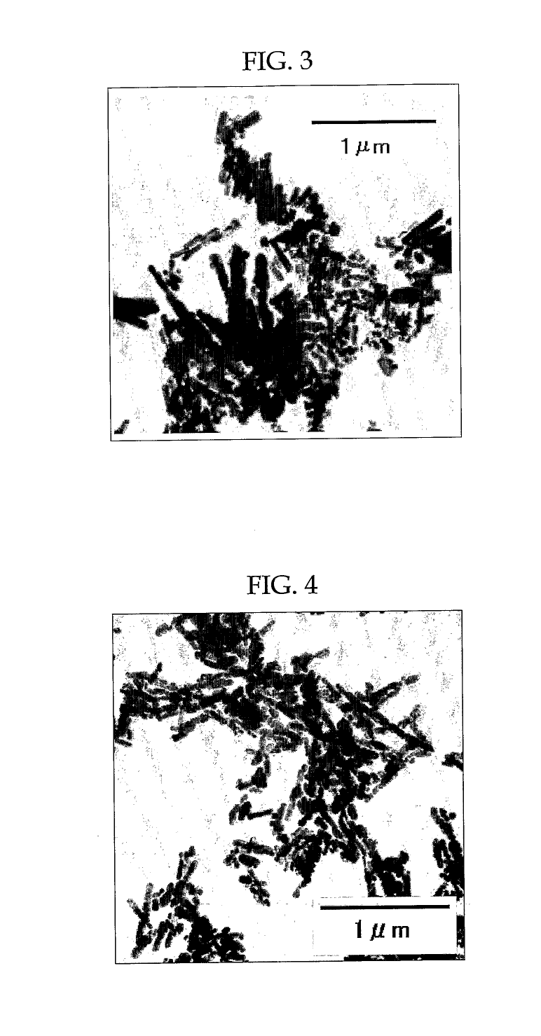

The sediment carbonate was taken through a filter and dried. The dried sediment was measured using an X-ray diffractometer, and the measurement result showed that the sediment was comprised of strontium carbonate crystals. Further, the strontium carbonate crystals were observed using a transmission electron microscope (TEM). FIG. 3 shows a photograph of the strontium carbonate crystals. The transmission electron microscope photograph showed that strontium carbonate crystals having an average particle length of less than 1 μm and a high aspect ratio greater than 1 were obtained.

### Example 2

### Production of Carbonates

A carbonate was produced in the same manner as in Example 1 except that the carbonate source was changed to ammonium carbonate [(NH₄)₂CO₃] only in the increasing the number of carbonate particles. The obtained carbonate particles were examined in the same conditions as in Example 1. Just as in Example 1, it was found that strontium carbonate crystals having an average particle length of less than 1 μm and a high aspect ratio greater than 1 were obtained.

### Example 3

### Production of Carbonates

As shown in FIG. 2, based on the single-jet method, 625 mL of a 0.08 M strontium hydroxide [Sr (OH)₂] suspension which had been prepared from strontium hydroxide octahydrate used as the metallic ion source and poured in a stainless-steel pot was taken as solution A, and the temperature of the solution A was maintained at 10° C. On the other hand, 500 mL of a 0.1 M sodium carbonate [Na₂CO₃] aqueous solution as the carbonate source was taken as solution B, the solution B was poured in an amount of 62.5 mL into two feed tanks, respectively, and the temperature was maintained at 10° C., respectively. While stirring the solution A at 1,000 rpm with the temperature maintained at 10° C., 62.5 mL of the solution B was added to the solution A in the stainless-steel pot at an adding rate of 300 mL/minute and then mixed (Increasing the number of carbonate particles, Sr²⁺ ions excessively resided therein).

Next, under the same conditions of the temperature and the stirring stated above, 250 mL of a 0.1 M sodium carbonate [Na₂CO₃] aqueous solution (solution B) was slowly added to the solution A at an adding rate of 5 mL/minute (Increasing the volume of carbonate particles). Just as in Example 1, it was found that strontium carbonate crystals having an average particle length of less than 1 μm and a high aspect ratio greater than 1 were obtained.

### Example 4

### Production of Carbonates

As shown in FIG. 1, based on the double-jet method, 250 mL of water containing 8 g of sodium hydroxide [NaOH] was stirred at 1,000 rpm with the temperature maintained at 10° C. to prepare solution C. Then, 125 mL of a 0.4 M strontium chloride [SrCl₂] aqueous solution as the metallic ion source was prepared as solution A, and 125 mL of a 0.4 M sodium carbonate [Na₂CO₃] aqueous solution was prepared as solution B. The temperature of the solutions A and B was individually maintained at 10° C. The solutions A and B were added to the solution C at an adding rate of 300 mL/minute and then mixed (Increasing the number of carbonate particles).

Next, 250 mL of a 0.2 M strontium chloride [SrCl₂] aqueous solution and 250 mL of a 0.2 M sodium carbonate as the carbonate source were slowly added to the solution C at an adding rate of 5 mL/minute (Increasing the volume of carbonate particles). Just as in Example 1, it was found that strontium carbonate crystals having an average particle length of less than 1 μm and a high aspect ratio greater than 1 were obtained.

### Example 5

### Production of Carbonates

In a stainless-steel pot, 625 mL of a 0.1 M strontium hydroxide [Sr(OH)₂] suspension which had been prepared from strontium hydroxide octahydrate as the metallic ion source was poured, and the temperature of the metallic ion solution was maintained at 10° C. While stirring the metallic ion solution at 1,000 rpm with the temperature maintained at 10° C., carbon dioxide gas as the carbonate source was added to the metallic ion-containing solution at an adding rate of 400 mL/minute for 2 minutes through a tube equipped with Chemi Filter (manufactured by as One CO., LTD.) generating microscopic air bubbles while observing carbon dioxide gas using a carbon dioxide gas flowmeter (Increasing the number of carbonate particles).

With respect to the obtained carbonate, the particles were observed using a transmission electron microscope (TEM) to verify that no impurity was mixed therein, and then the number of the carbonate particles was measured. It was proved that the number of carbonate particles was increased.

Next, under the same conditions of the temperature and the stirring stated above, the carbon dioxide gas was injected to the strontium hydroxide [Sr(OH)₂] suspension at an adding rate of 40 mL/minute for 4 hours (Increasing the volume of carbonate particles).

With respect to the obtained carbonate, the particles were observed using a transmission electron microscope (TEM) to verify that no impurity was mixed therein, and then the size of the carbonate particles was measured. It was proved that the volume of carbonate particles was increased.

### —Verification of Carbonate Properties —

The sediment carbonate was taken through a filter and dried. The dried sediment was measured using an X-ray diffractometer, and the measurement result showed that the sediment was comprised of strontium carbonate crystals. Further, the strontium carbonate crystals were observed using a transmission electron microscope (TEM). FIG. 6 shows a photograph of the strontium carbonate crystals through the transmission electron microscope (TEM). The transmission electron microscope photograph showed that strontium carbonate crystals having an average particle length of less than 1 μm and a high aspect ratio greater than 1 were obtained.

### Example 6

### Production of Carbonates

As shown in FIG. 2, based on the single-jet method, a 0.14 M strontium hydroxide [Sr (OH)₂] suspension (pure water:methanol=1:4) which had been prepared from strontium hydroxide octahydrate as the metallic ion source in a stainless-steel pot was taken as solution A, and the temperature of the solution A was maintained at 5° C. On the other hand, a 0.10 M ammonium carbonate [(NH₄)₂CO₃] aqueous solution as the carbonate source was taken as solution B, the solution B was then poured into two feed tanks separately. While stirring the solution A with the temperature maintained at 5° C., the solution B in each of the two feed tanks was added to the solution A in the stainless-steel pot at an adding rate of 0.3 mL/minute and then mixed such that the ammonium carbonate in a number of moles equivalent to one-sixth of the number of moles of the strontium hydroxide [Sr (OH)₂] added at the time of preparation of the solution A was added to the solution A from each of the two feed tanks (Increasing the number of carbonate particles).

With respect to the obtained carbonate, the particles were observed using a transmission electron microscope (TEM) to verify that no impurity was mixed therein, and then the number of the carbonate particles was measured. It was proved that the number of carbonate particles was increased.

Next, the temperature of the 0.10 M ammonium carbonate [(NH₄)₂CO₃] aqueous solution (solution B) was raised to 45° C., and the solution B was added to the solution A with stirring from each of the two feed tanks at an adding rate of 1 mL/minute such that carbonate ions in a number of moles greater than the number of moles of the strontium source remaining in an insoluble state in the solution A were added (Increasing the volume of carbonate particles).

With respect to the obtained carbonate, the particles were observed using a transmission electron microscope (TEM) to verify that no impurity was mixed therein, and then the size of carbonate particles was measured. It was proved that the volume of carbonate particles was increased.

### —Verification of Carbonate Properties—

The sediment carbonate was taken through a filter and dried. The dried sediment was measured using an X-ray diffractometer, and the measurement result showed that the sediment was comprised of strontium carbonate crystals. Further, the strontium carbonate crystals were observed using a transmission electron microscope (TEM). FIG. 4 shows a photograph of the strontium carbonate crystals. Just as in Example 1, the transmission electron microscope photograph showed that strontium carbonate crystals having an average particle length of less than 1 μm and a high aspect ratio greater than 1 were obtained. Here, the measurement of 200 particles of the strontium carbonate showed that the strontium crystals had an average minor axis diameter of 55 nm and a long axis diameter of 190 nm.

### Example 7

### Production of Carbonates

Upon completion of the increasing the number of the carbonate particles in Example 5, the carbonate was passed through a filter to take strontium carbonates out. Remaining starting materials or the like were adequately washed away with a large amount of pure water. The sediment was added to 500 mL of pure water again and stirred uniformly and adequately to be dispersed in the pure water.

Next, to the dispersion, strontium hydroxide in a number of moles equivalent to twice the number of moles of the obtained sediment of strontium carbonates (SrCO₃), and a sodium hydroxide (NaOH) granule in a number of moles six times the number of moles of the strontium hydroxide were added and stirred adequately.

The temperature of the dispersion was raised to 90° C. While stirring the dispersion, from each of two feed tanks with the temperature maintained at 60° C., a 8 M urea [(NH₂)₂CO] aqueous solution was added to the dispersion at an adding rate of 100 mL/minute in an amount of 250 mL, separately.

Next, the dispersion was continuously stirred for 2 hours with the temperature maintained at 90° C. (Increasing the volume of carbonate particles).

With respect to the obtained carbonate, the particles were observed using a transmission electron microscope (TEM) to verify that no impurity was mixed therein, and then the size of the carbonate particles was measured. It was proved that the volume of carbonate particles was increased.

### Example 8

### Production of Carbonates

Carbonate was produced in the same manner as in Example 7 except that a 8M urea ([NH₂]₂CO) aqueous solution was added to the dispersion from each of two feed tanks with the temperature maintained at 60° C., at an adding rate of 500 mL/minute in an amount of 250 mL, separately. Just as in Example 7, it was proved that strontium carbonate crystals having a high aspect ratio greater than 1 were obtained.

### Example 9

### Production of Carbonates

Carbonate was produced in the same manner as in Example 6 except that a calcium hydroxide suspension was used instead of the strontium hydroxide suspension. Just as in Example 6, it was proved that calcium carbonate crystals having a high aspect ratio greater than 1 were obtained. Further, when a barium hydroxide suspension, a zinc hydroxide suspension, or a lead hydroxide suspension was used instead of the strontium hydroxide suspension, it was also proved that barium carbonate crystals, zinc carbonate crystals, or lead carbonate crystals each having a high aspect ratio greater than 1 were obtained.

### —Verification of Carbonate Properties—

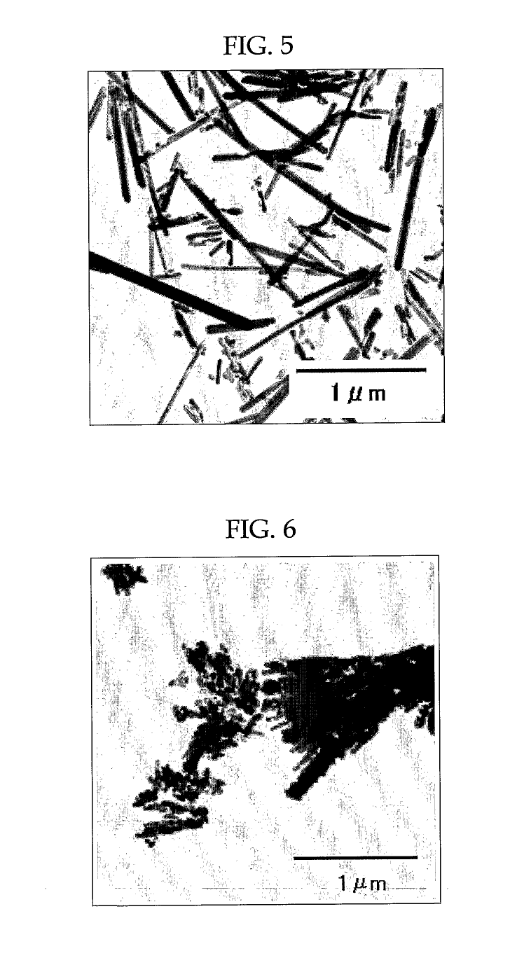

The sediment carbonate was taken through a filter and dried. The dried sediment was measured using an X-ray diffractometer, and the measurement result showed that the sediment was comprised of strontium carbonate crystals. Further, the strontium carbonate crystals were observed using a transmission electron microscope (TEM). FIG. 5 shows a photograph of the strontium carbonate crystals. The transmission electron microscope photograph showed that strontium carbonate crystals having an average particle length of less than 1 μm and a high aspect ratio greater than 1 were obtained.

### Comparative Example 1

### Production of Carbonates

Carbonates were produced in the same manner as in Example 1 except that the increasing the volume of carbonate particles is omitted, and the carbonate particles were examined in the same conditions as in Example 1 (Increasing the number of carbonate particles).

### —Verification of Carbonate Properties—

The dried sediment carbonate was measured using an X-ray diffractometer, and the measurement result showed that the sediment was comprised of strontium carbonate crystals. Further, the strontium carbonate crystals were observed using a transmission electron microscope (TEM). FIG. 6 shows a photograph of the strontium carbonate crystals through the transmission electron microscope (TEM). The transmission electron microscope photograph showed that the obtained strontium carbonate crystals included spherically shaped particles having an average particle diameter of 50 nm to 100 nm and aggregated particles thereof.

### Comparative Example 2

### Production of Carbonates

In a vessel, a strontium nitrate [Sr (NO₃)₂] solution as the metallic ion source and a urea [(NH₂)₂ CO] aqueous solution as the carbonate source were mixed so as to prepare a mixture solution with respective concentrations thereof being 0.33 M. Next, the vessel with the obtained mixture solution poured therein was placed in a reaction vessel, the vessel was heated for 90 minutes so that the temperature of the solution was maintained at 90° C. with stirring the mixture solution in the vessel. Strontium carbonate crystals as the carbonates were produced by means of thermal decomposition of urea. The mixture solution was stirred at a stirring rate of 500 rpm.

### —Verification of Carbonate Properties —

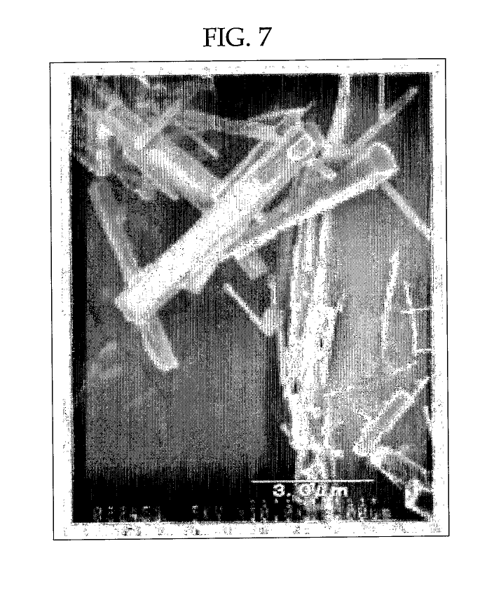

The strontium carbonate crystals were taken through a filter and dried. The dried strontium carbonate crystals were observed using a scanning electron microscope (SEM) (S-900, manufactured by Hitachi, Ltd.). FIG. 7 shows a scanning electron microscope photograph of the strontium carbonate crystals. Further, the strontium carbonate crystals were observed using a scanning electron microscope (SEM). The scanning electron microscope photograph showed that strontium carbonate crystals formed in a columnar or a rod-like shape having an average particle length of approx. 6.2 μm and with low aggregation were obtained. The percentage of the strontium carbonate crystals having a length of the average particle length ±α (α=0.5 μm) in the entire strontium carbonate crystals was 62%.

### Comparative Example 3

### Production of Carbonates

In a stainless-steel pot, with stirring 500 mL of a 0.05 M strontium nitrate [Sr (NO₃)₂] aqueous solution as the metallic ion source with a temperature of 25° C., 500 mL of a 0.05 M ammonium carbonate [(NH₄)₂CO₃] aqueous solution as the carbonate source was added to the strontium nitrate aqueous solution and mixed quickly without using an apparatus by which the adding rate was controllable. A white sediment was obtained instantaneously. After continuously stirring the mixture solution, the obtained sediment was taken through a filter and then dried in the same manner as in Example 1.

### —Verification of Carbonate Properties —

The dried sediment carbonate was measured using an X-ray diffractometer, and the measurement result showed that the sediment was comprised of strontium carbonate crystals. Further, the strontium carbonate crystals were observed using a transmission electron microscope (TEM). Strontium carbonate crystals having variations in form and size were only obtained.

The method for producing carbonates of the present invention makes it possible to control the carbonate particles as well as to effectively and easily produce carbonates having a constant particle size at high rates.

The carbonates produced by the method for producing carbonates of the present invention have an aspect ratio greater than 1, for example, the carbonates are formed in an acicular or a rod-like shape, therefore, the carbonates are suitably used for plastic reinforcing materials, friction materials, heat insulating materials, filters, and the like. Particularly in composite materials that have been subjected to a deformation such as orientated materials, it is possible to improve the intensity and the optical properties by the orientated particles.

When carbonates (crystals) produced by the method for producing carbonates of the present invention are dispersed in an optical polymer having a birefringence and subjected to an orientation treatment to thereby orientate binding chains of the optical polymer generally parallel to the carbonate particles, the birefringence brought by the orientation of the binding chains of the optical polymer can be counteracted with the birefringence of the carbonates. For this reason, carbonates produced by the method for producing carbonates of the present invention can be suitably used for optical components, especially for optical elements that the deflection property is important and high-precision is required.

1. A method for producing carbonates comprising:
increasing the number of carbonate particles, and
increasing the volume of the carbonate particles,
wherein a metallic ion source containing at least one selected from Sr²⁺ ions, Ca²⁺ ions, Ba²⁺ ions, Zn²⁺ ions, and Pb²⁺ ions is reacted with a carbonate source in a solution to thereby produce carbonates shaped to have an aspect ratio greater than 1.

2. The method for producing carbonates according to claim 1, wherein the metallic ion source is reacted with the carbonate source in a solution by a single-jet method.

3. The method for producing carbonates according to claim 1, wherein the metallic ion source is reacted with the carbonate source in a solution by a double-jet method.

4. The method for producing carbonates according to claim 1, wherein in the increasing the number of the carbonate particles, the number of moles of the metallic ion source to be reacted is equal to the number of moles of the carbonate source; in the increasing the volume of the carbonate particles, the number of moles of the metallic ion source to be reacted is equal to the number of moles of the carbonate source; and the number of moles of the metallic ion source to be reacted in the increasing the volume of the carbonate particle is greater than the number of moles of the metallic ion source in the increasing the number of the carbonate particles.

5. The method for producing carbonates according to claim 1, wherein in the increasing the number of the carbonate particles, the metallic ion source is reacted with the carbonate source such that the number of moles of the metallic ion source (a) is greater than the number of moles of the carbonate source (b) to produce carbonate particles, and in the increasing the volume of the carbonate particles, the carbonate source is reacted with the metallic ion source such that the number of moles of the carbonate source is greater than the difference between the number of moles of the metallic ion source (a) and the number of moles of the carbonate source (b) to increase the volume of the carbonate particles.

6. The method for producing carbonates according to claim 1, wherein the carbonate source to be reacted in the increasing the number of the carbonate particles and the carbonate source to be reacted in the increasing the volume of the carbonate particles are the same compound.

7. The method for producing carbonates according to claim 6, wherein the increasing the number of the carbonate particles comprises adding at least any one of the metallic ion source and the carbonate source to the solution having a temperature of −10° C. to 40° C. at an adding rate of 0.01 mL/minute to 1,000 mL/minute to be mixed in the solution.

8. The method for producing carbonates according to claim 7, wherein the increasing the volume of the carbonate particles comprises adding at least any one of the metallic ion source and the carbonate source to the solution under a condition of a temperature higher than the reaction temperature in the increasing the number of the carbonate particles and an adding rate of 0.01 mL/minute to 1,000 mL/minute to be mixed.

9. The method for producing carbonates according to claim 1, wherein the adding rate and the adding time of the carbonate source are controlled in each of the increasing the number of the carbonate particles and the increasing the volume of the carbonate particles to be reacted with the metallic ion source.

10. The method for producing carbonates according to claim 9, wherein in the increasing the number of the carbonate particles, the adding rate of the carbonate source is 300 mL/minute to 2,000 mL/minute, and the adding time is 10 seconds to 30 minutes; and in the increasing the volume of the carbonate particles, the adding rate of the carbonate source is less than 300 mL/minute and the adding time is 0.5 hours or more.

11. The method for producing carbonates according to claim 9, wherein the carbonate source is carbon dioxide gas.

12. The method for producing carbonates according to claim 9, wherein the metallic ion source-containing solution is maintained at a temperature of −10° C. to 40° C. in the increasing the number of the carbonate particles.

13. The method for producing carbonates according to claim 9, wherein the reaction temperature in the increasing the volume of the carbonate particles is higher than the reaction temperature in the increasing the volume of the carbonate particles.

14. The method for producing carbonates according to claim 9, wherein the metallic ion source is a metallic hydroxide.

15. The method for producing carbonates according to claim 1, wherein the metallic ion source comprises at least one selected from NO₃⁻, Cl⁻, and OH⁻.

16. The method for producing carbonates according to claim 1, wherein the carbonate source comprises at least one selected from the group consisting of ammonium carbonate, sodium carbonate, sodium hydrogen carbonate, urea, and carbon dioxide gas.

17. The method for producing carbonates according to claim 1, wherein the increasing the number of the carbonate particles comprises adding a carbonate source-containing aqueous solution to the metallic ion source-containing solution at an adding rate of 0.01 mL/minute to 1,000 mL/minute while maintaining the temperature of the metallic ion source-containing solution at −10° C. to 40° C. to be mixed with the metallic ion source-containing solution, and the increasing the volume of the carbonate particles comprises adding any one of the carbonate source-containing aqueous solution and a gas to the metallic ion-containing solution under a condition of a temperature higher than the reaction temperature in the increasing the number of the carbonate particles and an adding rate of 0.01 mL/minute to 1,000 mL/minute to be mixed.

18. The method for producing carbonates according to claim 1, wherein the solution comprises water.

19. The method for producing carbonates according to claim 1, wherein the solution comprises a solvent.

20. The method for producing carbonates according to claim 19, wherein the solvent comprises at least one selected from the group consisting of methanol, ethanol, isopropyl alcohol, and 2-amino ethanol.
